(19) United States
(12) Patent Application Publication
(10) Pub. No.: US 2011/0057123 A1
(43) Pub. Date: Mar. 10, 2011

(54) STERILIZING LAUNDRY BALL

(75) Inventor: Yi-Ta Ho, Hsinchu (TW)

(73) Assignee: LITE-ON IT CORP., Taipei City (TW)

(21) Appl. No.: 12/873,693

(22) Filed: Sep. 1, 2010

(30) Foreign Application Priority Data
Sep. 9, 2009 (CN) 200910170761.0

(51) Int. Cl. G21K 5/00; H02J 7/00; H02M 7/06

(52) U.S. Cl. 250/492.1; 320/107; 320/108; 363/126

(57) ABSTRACT

A laundry ball with a sterilization function includes a main body, a LED module coupled to the main body for emitting a light, and a power supply module coupled to the LED module in order to provide a power to the LED module. An internal power supply or an external power supply may be used for charging a battery module through the power supply module.

### FIELD OF THE INVENTION

The present invention relates to a laundry ball, and more particularly to a sterilizing laundry ball.

### BACKGROUND OF THE INVENTION

Please refer to FIG. 1A, which is a schematic diagram illustrating the appearance of a typical laundry ball. Using a laundry ball 10 while washing clothes not only avoids the clothes from being twisted, but also exhibits cleaning effect by providing additional friction with the clothes.

FIG. 1B is a schematic diagram illustrating another conventional laundry ball. The laundry ball 12 is designed with a special structure and is capable of changing directions of water stream so as to provide a variety of impacts on clothes.

Besides the shape or the structure design, recently, modifications are focused on the materials of laundry balls, and the intention to reduce the use of washing powders or detergents containing fluorescent agent or other chemicals, which may become residuals left on the clothes.

The laundry ball illustrated in FIG. 1C is one of the examples. The laundry ball 14 contains particles made of nanotech materials. When water stream flows through the laundry ball 14, water clusters will be broken by the particles. Therefore, water molecules may readily penetrate fibers of the clothes so as to have contaminants removed from the clothes along with the water stream.

In addition to modifications on structures or materials of laundry balls for improving cleaning ability, it is desirable to provide laundry balls with a sterilization function in order to expand the utilities of laundry balls.

### SUMMARY OF THE INVENTION

The present invention provides a laundry ball which comprises: a main body; an LED module coupled to the main body for emitting a light in order to provide a sterilization effect; and a power supply module coupled to the LED module for providing a power to the LED module.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a schematic diagram illustrating the appearance of a conventional laundry ball;

FIG. 1B is a schematic diagram illustrating another conventional laundry ball;

FIG. 1C is a schematic diagram illustrating a further conventional laundry ball;

FIG. 2 is a schematic diagram illustrating a sterilizing UV lamp;

FIG. 3A is a schematic diagram illustrating a configuration of a laundry ball according to an embodiment of the present invention;

FIG. 3B is a schematic diagram illustrating a first embodiment of circuitry applicable to the laundry ball of FIG. 3A;

FIG. 3C is a schematic diagram illustrating a second embodiment of circuitry applicable to the laundry ball of FIG. 3A;

FIG. 3D is a schematic diagram illustrating a third embodiment of circuitry applicable to the laundry ball of FIG. 3A;

FIG. 3E is a schematic diagram illustrating a fourth embodiment of circuitry applicable to the laundry ball of FIG. 3A

FIG. 4 is a schematic diagram illustrating a structure of a laundry ball according to an embodiment of the present invention;

FIG. 5 is a schematic diagram illustrating a structure of a laundry ball according to another embodiment of the present invention; and

FIG. 6A˜FIG. 6C are schematic diagrams illustrating a structure of a laundry ball according to a further embodiment of the present invention.

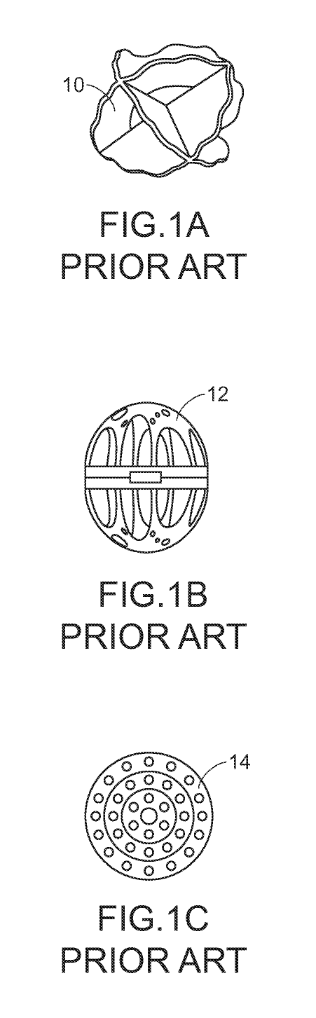

### DETAILED DESCRIPTION OF PREFERRED EMBODIMENTS

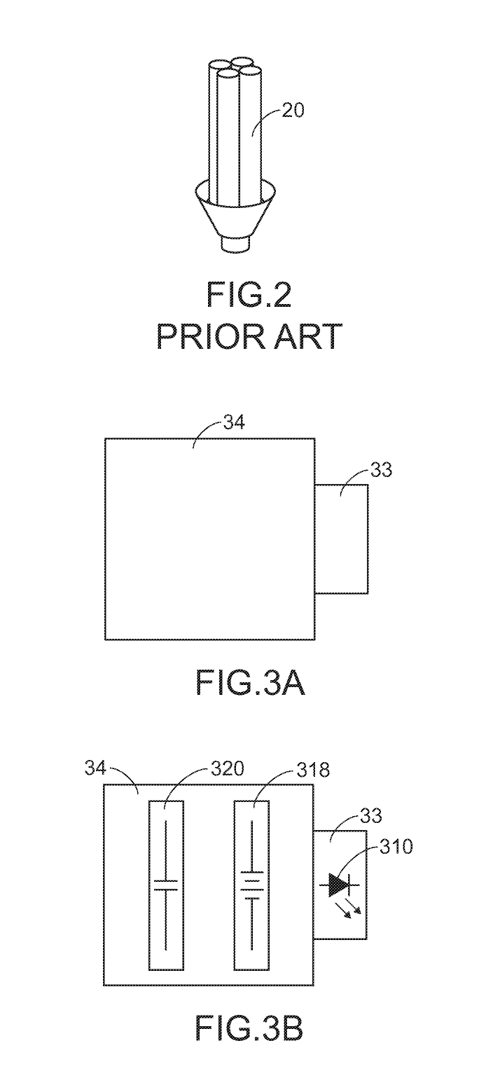

As commonly known, UV light performs well in sterilization. A typical form of means for emitting UV light is a UV lamp, as shown in FIG. 2. The UV lamp 20 is widely used in a variety of apparatus, e.g. dish dryer, sterilizing box, filter assembly for air or water, etc., for sterilization. However, it is impractical to incorporate a UV lamp into a laundry ball for incompatible sizes, and more particularly as mercury poisonous to human beings and environment is commonly used in the UV lamp 20. Vibration of the laundry ball during the clothes-washing process likely causes leakage of mercury.

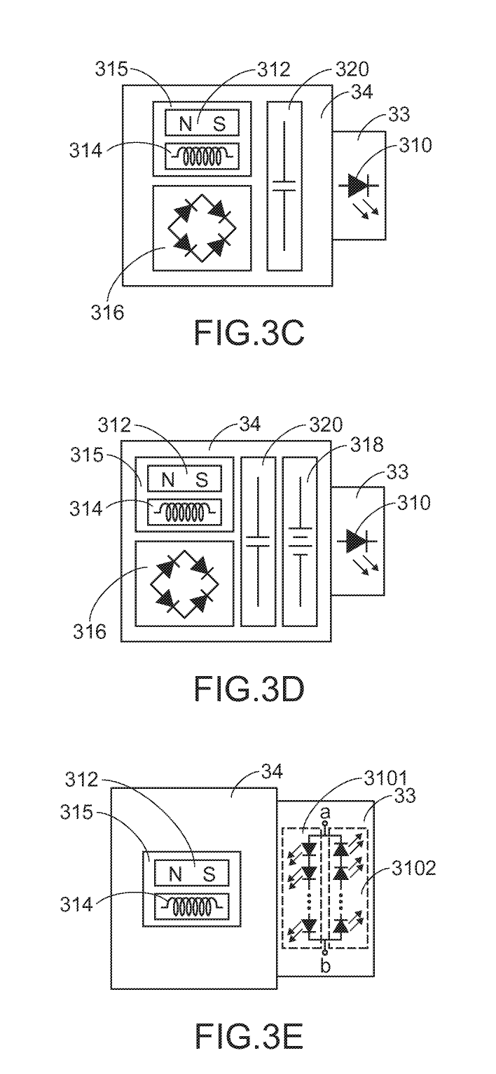

FIG. 3A is a schematic diagram illustrating a configuration of a laundry ball according to an embodiment of the present invention. The laundry ball exhibits a sterilization function by emitting UV light. In considerations of size compatibility and safety, a UV LED capable of emitting UV light with wavelength, for example, ranged between 100 nm and 400 nm, is adapted in the present embodiment. It is to be noted, however, that any other UV-emitting device having a compatible size with the laundry ball and preferably mercury-free can be used in the present invention for sterilization. The laundry ball in this embodiment includes an LED module 33 for emitting a UV light exhibiting a sterilization function; and a power supply module 34 for providing a DC current or an AC current required by the LED module 33 for light emission.

In FIG. 3B to 3E, different LED modules 33 adapted to different types of driving currents are illustrated. For supplying the driving currents, different power supply modules 34 are exemplified in FIG. 3B˜FIG. 3E, wherein the power supply modules 34 illustrated in FIG. 3B, FIG. 3C and FIG. 3D output DC current, and the power supply module 34 illustrated in FIG. 3E outputs AC current. The AC current is transformed to the DC driving current generated by the power supply module 34 flows into the anode of a UV LED 310 included in the LED module 33 to the cathode of the UV LED 310. There are a variety of approaches to implement the power supply modules 34, which will be described with reference to FIGS. 3B˜3E. By supplying power to the LED module 33, UV light can be emitted by the LED included in the LED module 33 to provide the sterilization function of the laundry ball.

Please refer to FIG. 3B. An embodiment of the circuitry of a laundry ball according to the present invention includes a rechargeable battery module 318 and a charging module 320. The charging module 320 charges the battery module 318 through an external power supply or an internal power supply, and then the battery module 318 provides a power to the UV LED 310 when necessary. FIG. 3C illustrates another embodiment of the circuitry of a laundry ball according to the present invention. The power supply module 34 includes an inductor module 315 and a rectifier module 316. The induction module 315 includes a magnetic member 312 and a coil member 314, wherein the coil member 314 senses a change in magnetic field, which is caused due to the movement of the magnetic member 312 relative to the coil member 314, so as to induce an AC current. As a result, the induction module 315 is able to dynamically detect the movement of the laundry ball, and generate an AC current in response. The rectifier module 316 then transforms the AC current into a DC current, and the charging module 320 utilizes the DC current to provide the power to the UV LED 310.

FIG. 3D illustrates a third embodiment of the circuitry of a laundry ball according to the present invention. The power supply module 34 in this embodiment includes a battery module 318, a charging module 320, an induction module 315, and a rectifier module 316, wherein the induction module 315 dynamically generates an AC current in response to the movement of the laundry ball, the rectifier module 316 transforms the AC current into a DC current, the charging module 320 serves as an internal power supply to charge the battery module 318 with the DC current, and the battery module 318 drives the UV LED 310 included in the LED module 33.

Therefore, when a washing machine starts a clothes-washing program, the laundry ball put inside the machine will rotate back and forth in the washing machine. Meanwhile, the rotation of the laundry ball causes vibration of the induction module 315 and thus movement of a magnetic member 312 included in the induction module 315. Accordingly, electromagnetic conversion is induced by a coil module 312 included in the induction module 315. The electromagnetic conversion results in an AC current, and the rectifier module 316 transforms the AC current into a DC current. The DC current is used to charge the battery module 318 which serves as an internal power supply for the UV LED 310.

The induction module 315, on the other hand, will stop performing the electromagnetic conversion so as to stop outputting AC current to the rectifier module 316 as soon as the laundry machine stops operating. Consequently, the rectifier module 316 stops outputting DC current to the charging module 320, and thus the charging module 320 stops charging the battery module 318. Then, after the power provided by the battery module 318 is completely consumed, the UV LED 310 terminates the emission of the UV light. In short, when the laundry machine stops its operation, the UV LED 310 automatically stops emitting the UV light. In this manner, the adverse effect resulting from the radiation accompanying the UV light, e.g. harm to human skin, can be exempted from.

FIG. 3E is a schematic diagram illustrating a fourth embodiment of the circuitry of a laundry ball according to the present invention. In this embodiment, an LED module 33 which is adapted to AC current is included. There are two series of LEDs 3101 and 3102, each electrically connected between a node “a” and a node “b”, in the LED module 33. When AC current flows from the node “a” to the node “b”, the LED series 3101 which is forward biased emits UV light. On the other hand, when AC current flows from the node “b” to the node “a”, it is the LED series 3102 forward biased and thus the LED series 3102 emits UV light instead of the LED series 3101. Moreover, the laundry ball includes a power supply module 34. The power supply module 34 includes an induction module 315 that is composed of a magnetic module 312 and a coil module 314.

When the laundry ball rotates back and forth in the washing machine, the magnetic module 312 and the coil module 314 cooperate to conduct electromagnetic conversion. The coil module 314 detects the changes of the magnetic field caused by the movement of the magnetic module 312 and generates and outputs an AC current through the node “a” and the node “b”. The AC current is then used to drive the LED series 3101 and the LED series 3102 in the LED module 33 to emit a light with 100 nm to 400 nm wavelength which is effective on sterilization.

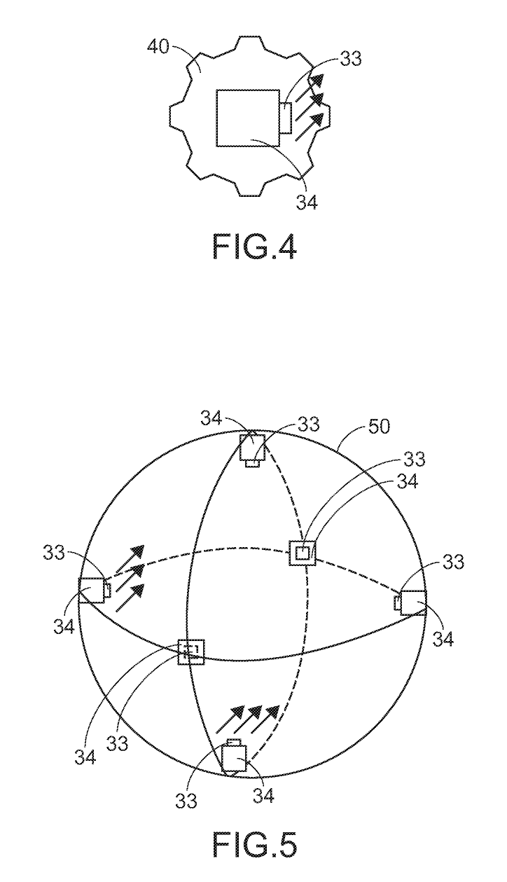

Afterwards, three embodiments of structures and examples of applications of laundry balls according to the present invention are illustrated with reference to FIGS. 4˜6. The circuitry as shown in FIG. 3D, which includes a LED module 33 and a power supply module 34 composed of an induction module, a rectifier module, a charging module and a battery module to provide a DC current to a UV LED, is used in each of the laundry balls for illustration only. It is understood that other circuitry can also be used with the structures of the laundry balls described hereinafter. In the embodiment as shown in FIG. 4, the laundry ball has a common spherical structure. The circuit portion including the LED module 33 and the power supply module 34 is disposed inside the spherical structure for providing sterilization function when the washing machine is operating.

In the embodiment shown in FIG. 5, the laundry ball has a cage structure. The cage structure includes a cage skeleton 50, and six circuit portions for providing UV sterilization function, each including the LED module 33 and the power supply module 34 and attached onto the cage skeleton 50 with inward UV light emission. When clothes are to be processed, they are placed inside the cage skeleton 50 of the laundry ball and the laundry ball is put into the washing machine. While the laundry ball is rotating back and forth in the operating laundry machine, UV light is emitted to sterilize the clothes. The rotation of the laundry ball causes each power supply module 34 to generate a DC current so as to provide power to the corresponding UV LED 34.

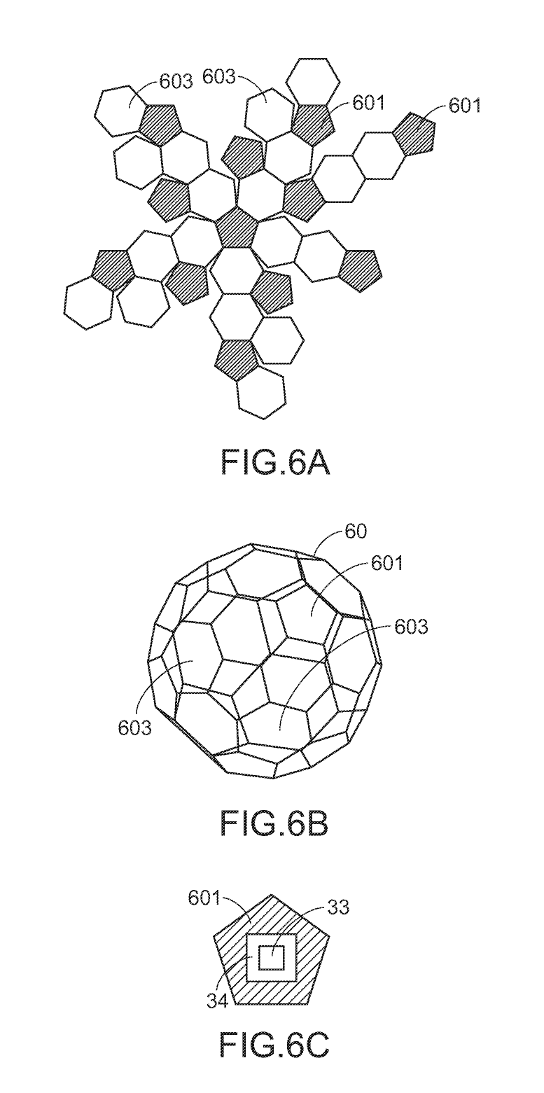

FIG. 6A to FIG. 6C are schematic diagrams illustrating another embodiment of a structure of a laundry ball according to the present invention. In this embodiment, the laundry ball has a soccer structure. The surface of the laundry ball 60 is composed of twelve pentangle plastic flakes 601, and twenty hexagon plastic flakes 603. A LED module 33 and a power supply module 34 are attached on one of the pentangle plastic flakes, and more than one set of LED module 33 and a power supply module 34 can be used to improve sterilization effect.

For loading clothes to be processed into the laundry ball, some of the pentangle plastic flakes 601 and/or some of the hexagon plastic flakes 603 are made detachable. The user puts clothes into the laundry ball 60 from the openings resulting from the detached flakes, and then reassembles the laundry ball 60 to restore the soccer structure. Then the laundry ball with clothes loaded therein may be put inside the washing machine to have the clothes processed. Meanwhile, the circuit portion of the laundry ball dynamically emits UV light to sterilize the clothes when the laundry ball rotates back and forth during the operation of the washing machine.

In brief, by providing a laundry ball with a UV-emitting mechanism, a sterilization function can be exhibited; by providing the laundry ball with a charging mechanism, the UV light emission of the laundry ball can be lasted for a relatively long term; and by providing the laundry ball with an operation-detecting mechanism, unnecessary UV light emission of the laundry ball can be avoided. In practical applications, for example, the number and allocation of the circuit portion vary with the structure of the laundry ball, which may be, for example, a solid structure or a cage structure with a spherical, polygonal, cylindrical or any other suitable appearance.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A laundry ball, comprising:
a main body;
a LED module attachable onto the main body for emitting a light in order to provide a sterilization effect; and
a power supply module coupled to the LED module for providing a power to the LED module.

2. The laundry ball according to claim 1, wherein the main body has a solid structure or a cage structure.

3. The laundry ball according to claim 1, wherein the main body has a spherical, polygonal or cylindrical appearance.

4. The laundry ball according to claim 1, wherein the LED module is a UV LED and the wavelength of the light is ranged between 100 nm and 400 nm.

5. The laundry ball according to claim 1, wherein the power supply module comprises:
a battery module electrically connected to the LED module for providing the power to the LED module.

6. The laundry ball according to claim 5, wherein the power supply module further comprises:
a charging module electrically connected to the battery module for charging the battery module through an internal power supply or an external power supply.

7. The laundry ball according to claim 6, wherein the power supply module further comprises:
an induction module, which comprises:
a magnetic member; and
a coil member coupled to the magnetic element for detecting a change in a magnetic field, which is caused by movement of the magnetic member relative to the coil member, and optionally generating an AC current which is induced by the change of the magnetic field; and
a rectifier module electrically connected to the induction module and the charging module for transforming the AC current into a DC current which is used as the internal power supply.

8. The laundry ball according to claim 1, wherein the power supply module comprises:
an induction module, comprises:
a magnetic member; and
a coil member coupled to the magnetic element for detecting a change in a magnetic field, which is caused by movement of the magnetic member relative to the coil member, and optionally generating an AC current which is induced by the change of the magnetic field; and
a rectifier module electrically connected to the induction module and the charging module for transforming the AC current into a DC current to be supplied to the LED module.

9. The laundry ball according to claim 1, wherein the power supply module comprises:
an induction module, comprises:
a magnetic member; and
a coil member coupled to the magnetic element for detecting a change in a magnetic field, which is caused by movement of the magnetic member relative to the coil member, and optionally generating an AC current which is induced by the change of the magnetic field.
